(19) United States
(12) Patent Application Publication
(10) Pub. No.: US 2007/0157890 A1
(43) Pub. Date: Jul. 12, 2007

(54) Livestock habitat

(76) Inventor: Kamaljit S. Kaura, Irvine, CA (US)

Correspondence Address: PATENT LAW & VENTURE GROUP, 2424 S.E. BRISTOL, SUITE 300, NEWPORT BEACH, CA, 92660, US

(21) Appl. No.: 11/328,754

(22) Filed: Jan. 9, 2006

(51) Int. Cl. A01K 1/03

(52) U.S. Cl. 119/496

(57) ABSTRACT

An animal shelter apparatus is formed as a unitary enclosure having a sidewall defining an open floor. The enclosure rests on a pair of spaced apart beams supported by a generally horizontal support surface. The sidewall is surrounded in an abutting relationship with the support surface formed as a peripheral berm. The sidewall provides two spaced apart wheels that are above the support surface when the enclosure rests on the support surface and contact the support surface when the enclosure is tilted toward the wheels.

### BACKGROUND OF THE INVENTION

1. Field of the Present Disclosure

This invention relates generally to animal shelters and more particularly to an animal shelter with novel construction and use.

2. Description of Related Art Including Information Disclosed Under 37 CFR 1.97 And 1.98

Goetz, U.S. Des. 334,087 describes a design for a pet carrier or similar article. Van Buren, U.S. Des. 450,890 describes a design for a calf nursery. Parker, U.S. 823,544 describes a hutch having a fixed stud on each side and a long lever mounted near one end on each stud, a roller and roller axis carried by each lever at one end, and the opposite end of each lever is formed as a handle, and guides fixed to the hutch through which the handle ends of the levers pass. Patterson, U.S. Pat. No. 3,785,344 describes a cage apparatus for confining an animal and preventing undesired movement of the cage including wheels mounted at the rear thereof, resilient support means mounted at the front of the cage to support the cage and to provide reaction forces in substantially the opposite direction from forces exerted by the animal in the cage such that the cage tends to move in substantially one direction only; and, transport means for connecting to the front end of the cage to render the cage transportable. Tellers, U.S. Pat. No. 4,292,929 describes an incubator particularly useful for calves and the like comprising a wheel supported generally box-like structure with a door to permit placement of the calf into, and removal of the calf from, the incubator, a heat source in the top wall, an opening in the front wall for feeding and a pail support assembly proximate the opening. Goetz, U.S. Pat. No. 5,220,885 describes a portable litter box for a cat or other domesticated animal comprising a housing having upper and lower sections detachably securable to provide a substantially closed container. The sections are stackable or nestable for storage, shipping and/or display. Preferably, the upper section includes an opening for ingress and egress to the housing and a carrying handle for the box as well as means for holding a freshener; the lower section may include skid resistant feet. Pins are provided for detachably securing the sections together in assembly. Ho, U.S. Pat. No. 5,467,734 describes an animal house including a number of elements that can be easily assembled and disassembled, the elements can be arranged in a compact configuration and can be packaged in a small box such that the animal house having a configuration that is good for transportation purposes. The animal house includes four wheels disposed in the bottom portion for facilitating movement of the animal house. Four stops are slidably engaged in the animal house for engaging with the wheels so as to limit rotational movement of the wheels. Markey et al., U.S. Pat. No. 5,551,371 describes a pet enclosure having a generally hollow box-shaped base and a ceiling, which is hingedly attached to the base. The hinged ceiling allows simplified access to the interior of the pet enclosure for cleaning, whelping or the like. The ceiling of the pet enclosure includes a chimney within which is located a passive vent which can be opened or closed to allow airflow through the pet enclosure to be controlled. A further embodiment of the pet enclosure includes an optional plastic curtain door and/or a solar powered vent fan, which replaces the passive vent. Busch, U.S. Pat. No. 6,295,765 describes a movable shelter for providing a shelter for animals that would be dry and warm. The movable shelter includes a base member including a first sprocket adapted to be rotatably mounted upon a ground such as a cement slab and also including a shaft securely mounted to the first sprocket for rotation therewith and being adapted to be generally perpendicular to the ground; and also includes a building structure having a open bottom, side walls, front wall, back wall, a ceiling, and an opening in the front wall with the building structure being securely mounted upon the shaft for rotation therewith; and further includes a rotation assembly for rotating the building structure. Bogner et al., U.S. Pat. No. 6,425,347 describes a portable livestock-incubating device that is formed of a rectangular container having and incubating volume forming an incubating chamber defined by the zone within the incubating volume. Each end wall further includes an access door hingedly attached to an upper portion above a clean out door for providing ingress and egress of livestock. Each access door has an exhaust vent located at an upper portion whereby heated air, generated via an electric heater within said the incubating chamber exhausts therethrough. A base with wheels mounted thereon for facilitating transportation of the portable livestock-incubating device. Craft et al., U.S. Pat. No. 6,036,204, discloses a hamper that includes a body portion having a front wall, a rear wall, and two side walls all extending upwardly from a bottom surface to form an open top. A cover portion is pivotally mounted to the body portion to close the open top. Wheels are positioned at the bottom of the rear wall to render the hamper mobile. For such purpose, a handle assembly is provided in the form of a U-shaped handle having opposed branches interconnected at one end by a grip area. The other end of the branches are pivotally connected to the body portion. A bar extends between the branches and carries a pull tab and a lock lug. The lock lug is received in a slot formed in the body portion to hold the handle in an upright position so that the hamper can be transported on the wheels. If desired to pivot the handle to a stowed position during periods of non-use, the pull tab is merely flexed and the lock lug comes out of the slot so that the handle can be rotated.

Our patentability search described above teaches a variety of animal enclosures, however, the related art does not teach an animal enclosure capable of being nested for economy in transport and storage. The prior art also does not teach incorporated raised wheels that only contact a surface for rolling the enclosure when the enclosure is tilted by at least 30 degrees. The prior art also does not teach structural engagements for base raising and rigidity, or a sliding floor panel that may be easily engaged with the enclosure. The present invention fulfills these needs and provides further related advantages as described in the following summary.

### BRIEF SUMMARY OF THE INVENTION

This disclosure teaches certain benefits in construction and use which give rise to the objectives described below.

An animal shelter apparatus is formed as a unitary enclosure having a sidewall defining an open floor. The enclosure rests on a pair of integrated spaced apart beams which support the enclosure on a ground surface. The sidewall is surrounded in an abutting relationship with the support surface formed as a peripheral berm covering the bottom flange of the sidewall. The sidewall provides two spaced apart wheels that are enclosed within the bottom flange and positioned above the support surface when the enclosure rests on the support surface and positioned above the beams when the enclosure rests on the beams. However, the wheels contact the support surface when the enclosure is tilted toward the wheels by about 30 degree tilt. The sidewall provides opposing slots for receiving a floor panel.

A primary objective inherent in the above described apparatus and method of use is to provide advantages not taught by the prior art.

Another objective is to provide an animal shelter that is economical to manufacture and easy to move from place to place and store.

A further objective is to provide such a shelter that is sealed by placement of a soil berm around it while the animal within rests on the soil surface within the shelter or on a slide-in panel engaged with the bottom of the shelter.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

The accompanying drawings illustrate the present invention. In such drawings:

FIG. 1 is a perspective view of the invention, an animal enclosure, showing a front door, side mounted wheels and tube carry mounts on top;

FIG. 2 is a partial sectional view thereof taken from line 3-3 in FIG. 1 and depicting the details of a bottom flange structure;

FIG. 3 is a vertical sectional view thereof as preferably used with a floor panel in place;

FIG. 4 is a vertical sectional view thereof as preferably used without the floor panel in place;

FIG. 5 is an side elevational view thereof showing a method of moving the invention on its built-in wheels; and

FIG. 6 is a vertical sectional view thereof of three units nested for compact storage.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

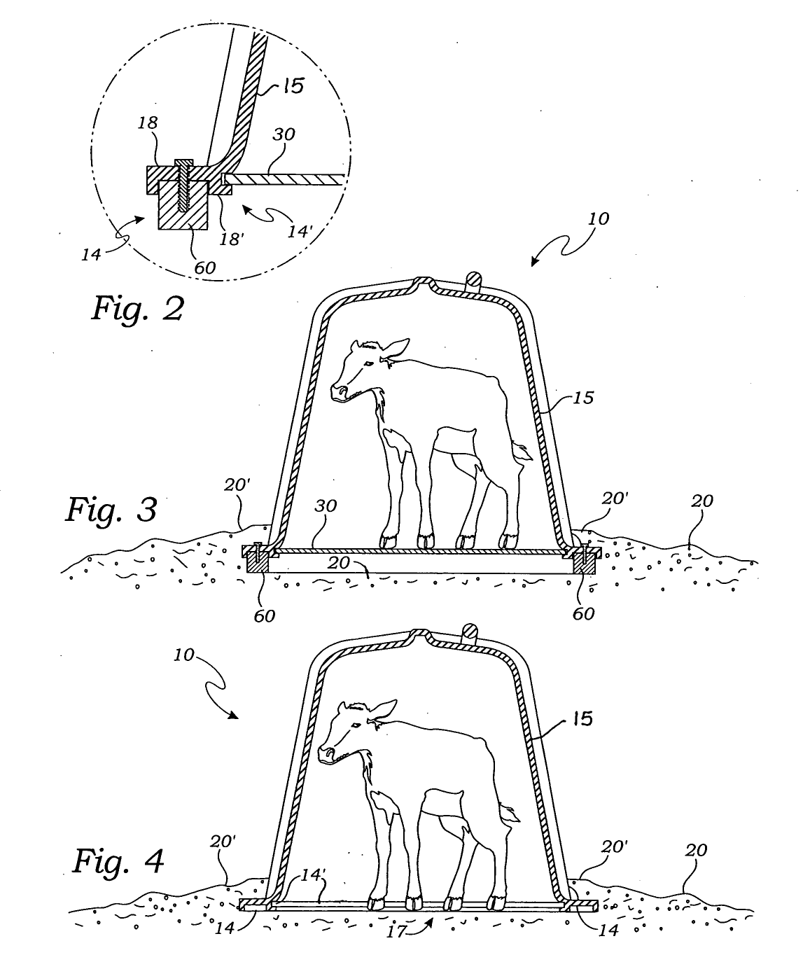

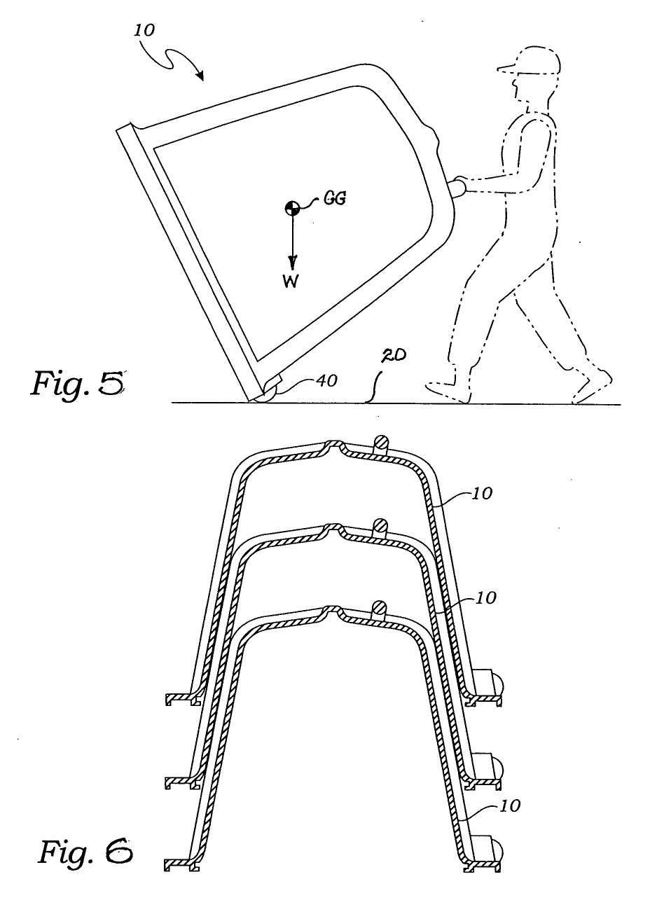

An animal shelter apparatus is constructed as a unitary rectangular enclosure 10 having a side wall 15 that curves at an angle upward to form a ceiling 16. It is preferably made by roto-molding in a durable plastic material. The sidewall 15 defines an open floor 17, and terminates downwardly into an outwardly directed peripheral flange 18 with a bottom contact surface 18′ (FIG. 2). The flange 18 is constructed with a pair of spaced apart downwardly directed horizontal grooves 14 built into the contact surface 18′, and on three interior sides of the flange 18, a horizontal inwardly directed groove 14′ is provided. In use, the apparatus is typically placed onto an earthen surface 20, and an earthen berm 20′ is built up around and over the flange 18 so that the bottom of the apparatus is sealed on all four sides. This prevents wind, water and animals from entering into the apparatus from below without the cost of building a floor into the apparatus if possible. The side wall 15 engages two spaced apart wheels 40 preferably positioned in parallel and located above the contact surface 18′ by a distance requiring a tilt of the apparatus toward the wheels 40 to place a center of gravity, shown in FIG. 5, approximately over the center of wheels 40 so that the apparatus is more easily moved. The specific tilt angle enables the center of gravity of the unit to be placed just slightly to the outside of the center of the wheels 40 so that only a slight weight need be supported by a person moving the apparatus as shown in FIG. 5. FIG. 5 shows that the weight vector is slightly toward the person moving the unit with respect to the center of the wheels 40. This enables the person moving the apparatus to be in complete control of the apparatus during movement from place to place.

A separable flat bottom panel 30, preferably of wood, fiberboard, plastic or similar structural materials is configured for being engaged within the inwardly directed groove 14′ as shown in FIGS. 2 and 3. When the surface 20 is not suitable, the panel 30 may be employed, and when the surface 20 is suitable for the intended purpose, the panel 30 may be removed.

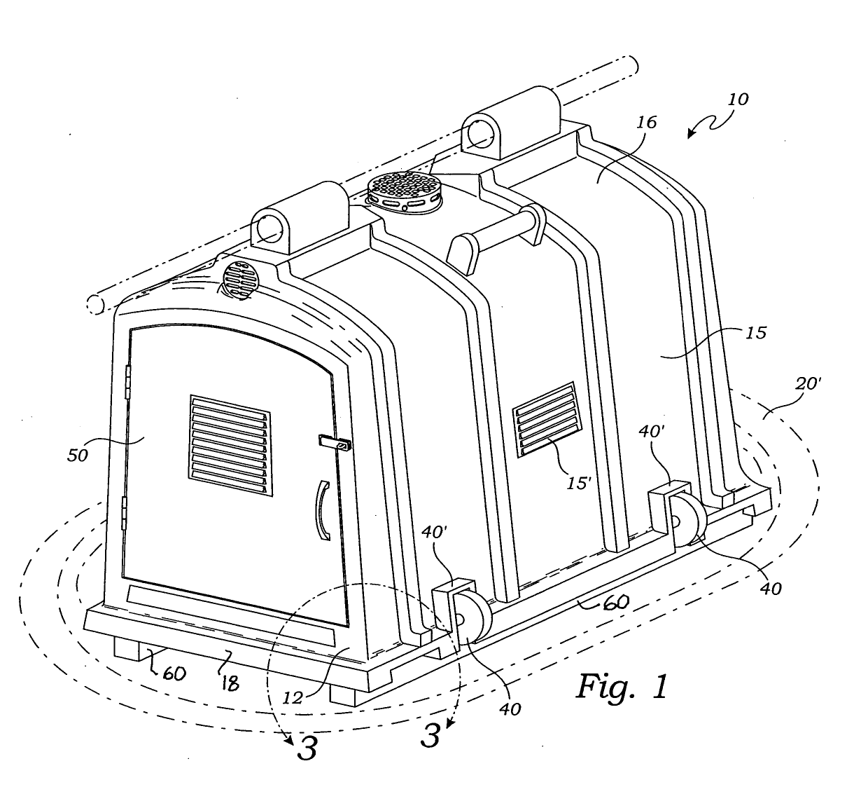

In one embodiment of the present invention, a pair of horizontally oriented structural beams, preferably of wood or plastic, such as 4×4 or 4×6 standard structural beams, or railroad ties, etc. are engaged with the grooves 14 as shown in FIGS. 1-3. This is advantageous when the earthen surface 20 is not suitable for placing the apparatus. This may be the case when the surface 20 is frozen or when it is too wet or when it consists of sharp stones or other undesirable debris. In this case the panel 30 is used to afford an improved accommodation as shown in FIG. 3.

Preferably, the sidewall 15 provides an access door 50 as shown in FIG. 1 for ingress and egress of the animals to be housed.

Preferably, the sidewall 15 is sharply sloped, as shown in FIG. 6, and with an open floor, the nesting of plural units of the present apparatus may be provided so as to enjoy the benefit of compact storage and shipping.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. (canceled)

2. The apparatus of claim 7 wherein the sidewall engages two spaced apart wheels positioned so that the wheels first contact the a support surface only when the apparatus is tilted over the wheels so as to place a center of gravity of the apparatus over the center of the wheels; whereby, the apparatus is movable with the wheels bearing the full weight of the apparatus.

3. (canceled)

4. (canceled)

5. (canceled)

6. (canceled)

7. An animal shelter apparatus adapted for engaging a horizontal supporting beam, and a horizontal floor panel; the apparatus comprising: a sidewall extending upwardly to form a ceiling and terminating downwardly with a horizontally oriented flange defining an open floor, the flange providing a downwardly facing surface having therein a first groove sized for receiving the supporting beam; the flange further providing a second groove oriented orthogonal to the first groove, the second groove positioned and oriented for receiving an edge of the horizontal floor panel.

8. An animal shelter apparatus comprising: a horizontal supporting beam; a horizontal floor panel; and a sidewall extending upwardly to form a ceiling and terminating downwardly with a horizontally oriented flange defining an open floor, the flange providing a downwardly facing surface having therein a first groove engaging the supporting beam; the flange further providing a second groove oriented orthogonal to the first groove, the second groove engaging an edge of the horizontal floor panel.
